(19) United States
(12) Patent Application Publication
(10) Pub. No.: US 2007/0104938 A1
(43) Pub. Date: May 10, 2007

(54) Foam cushion with a high water-absorption ability

(75) Inventor: Winston Lin, Taichung (TW)

Correspondence Address: BRUCE H. TROXELL;SUITE 1404, 5205 LEESBURG PIKE, FALLS CHURCH, VA, 22041, US

(73) Assignee: Union Looper Co., Ltd.

(21) Appl. No.: 11/269,755

(22) Filed: Nov. 9, 2005

(51) Int. Cl. B32B 3/26

(52) U.S. Cl. 428/304.4

(57) ABSTRACT

A foam cushion with a high water-absorption ability is made mainly from PVC powder and full of open air cells. The air cells in the foam cushion are broken to connect with one another and those on the surface of the foam cushion are broken to connect with open air. Thus, the foam cushion provides a good elastic buffering and high water-absorption ability.

### BACKGROUND OF THE INVENTION

1. Field of the invention

This invention relates to a foam cushion, particularly to one made from PVC powder and formed in one piece, having high water-absorption ability.

2. Description of the Prior Art

Common conventional foam cushion is mainly composed of PVC powder, dioctyl phthalate, synthetic calcium carbonate, clay, blowing agent and pigments. All the components are mixed together to become a paste, which is laid on a conveyer or a release paper and flattened by a roller and then, heated with a high temperature to form a foam cushion. Finally, via a thermal cast and a trimming device, the foam cushion can be cut or trimmed to become a foam product desired. Since the foam cushion is full of air cells inside it, able to provide a buffering rebounding, it can be widely applied to life or sports appliances.

But, the conventional foam cushion is always provided with closed cells, which, being not connected with one another, will rebound stronger when it is compressed. Therefore, such a foam cushion, if trimmed to be an insole or other sports cushions, will make the feet or the spots in contact with the sporting cushions feel uncomfortable or cause a sore of muscle in case of wearing for a long time. Moreover, when the conventional closed-cell one, such as an insole, is used, it may be unlikely to absorb the sweat excreted by feet, keeping the skin wetted, possible to cause a skin disease. Therefore, this invention has been devised to overcome the defects mentioned above.

### SUMMARY OF THE INVENTION

The prime object of this invention is to offer a foam cushion with high water-absorption ability.

The main characteristic of the invention is PVC powder formed as a foam cushion with numerous open cells, having high water-absorption ability.

The cells inside the foam cushion are connected with one another and those on the surface of the foam cushion are connected with open air, forming open cells. Thus, when the foam cushion is compressed by a user, it will buffer the rebounding force to make the user feel tender and comfortable. In addition, the cells of the foam cushion can help to absorb moisture, keeping the user's skin dryer and preventing it from growing skin diseases.

### BRIEF DESCRIPTION OF DRAWINGS

This invention is better understood by referring to the accompanying drawings, wherein:

FIG. 1 is a flow chart of a preferred embodiment of manufacturing a foam cushion with high water-absorption ability in the present invention;

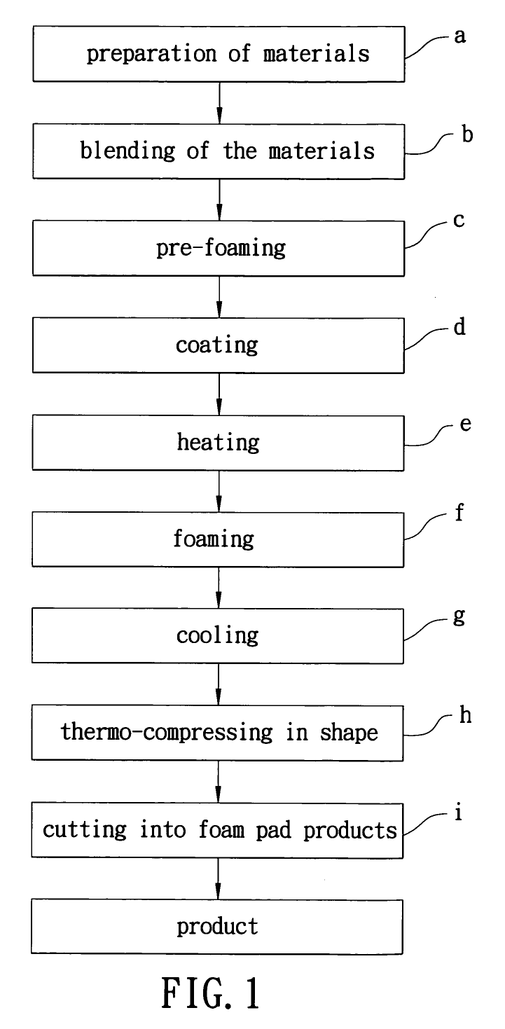

FIG. 2 is a flow chart of the preferred embodiment of manufacturing a foam cushion with high water-absorption ability in the present invention, showing the necessary equipment used for it;

FIG. 3 is a perspective view of an insole made of the foam cushion with a high water-absorption ability in the present invention; and

FIG. 4 is a partial magnified cross-sectional view of the foam cushion with high water-absorption ability in the present invention.

### DETAILED DESCRIPTION OF THE PREFERRED EMBODIMENT

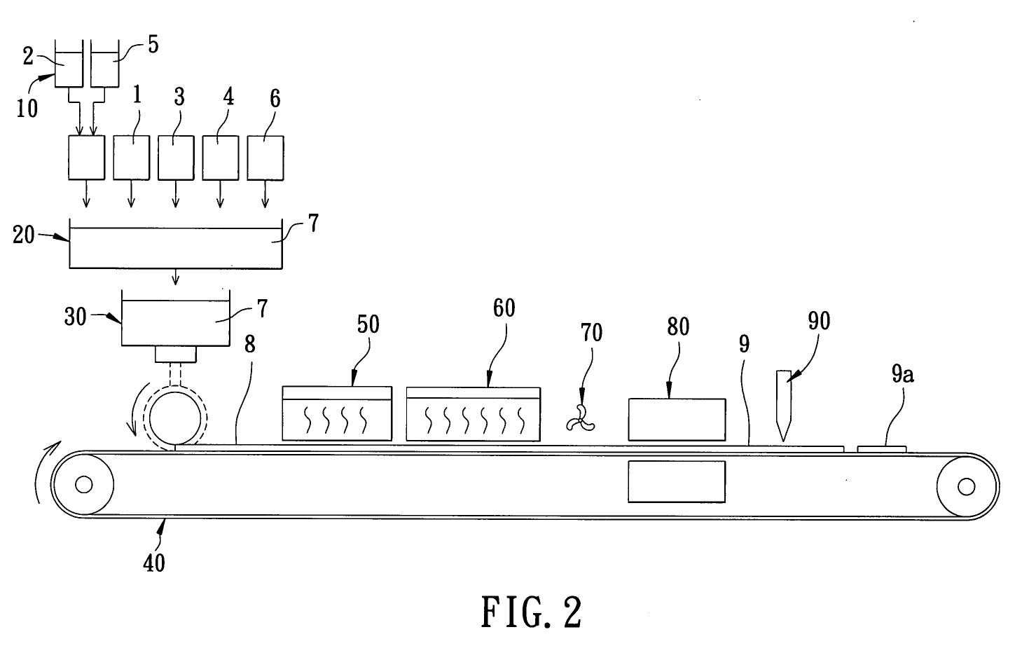

As shown in FIG. 2, a preferred embodiment of a foam with a high water-absorption ability in the present invention is produced in accordance with the procedures described as below:

(a) a first step of preparation of raw materials: PVC powder 1, dioctyl phthalate (DOP) 2 as a plasticizer, synthetic calcium carbonate 3, kaolin 4, a blowing agent 5 and pigments 6 contained in respective container 10;

(b) a second step of mixing: mixing the blowing agent 5 and the DOP 2 first, then, pouring it in a mixing device 20 for further mixing with other components to gain a liquid paste 7;

(c) a third step of pre-blowing: putting the liquid paste 7 in a medium tank 30 for a stationary staying at room temperature for about 8 hours to let the liquid paste 7 grow bubble;

(d) a fourth step of laying: laying the liquid paste 7 on a conveyer 40 to form a paste layer 8 with a proper thickness, after received the third step (c);

(e) a fifth step of heating: putting the paste layer 8 in a oven 50 for 3-10 minutes with a temperature between 80-90° C.;

(f) a sixth step of blowing: putting the paste layer 8, after received heating in the fifth step (e), in a oven 60 for 20-30 minutes with a temperature between 180-200° C. to enable the paste layer 8 to blow completely, forming a whole piece of foam cushion 9 with a proper thickness;

(g) a seventh step of cooling: keeping the foam cushion 9 cooled down by a cooling fan 70;

(h) an eighth step of thermal pressing: using a mold 80 to press thermally the foam cushion to obtain a desired figure or texture; and

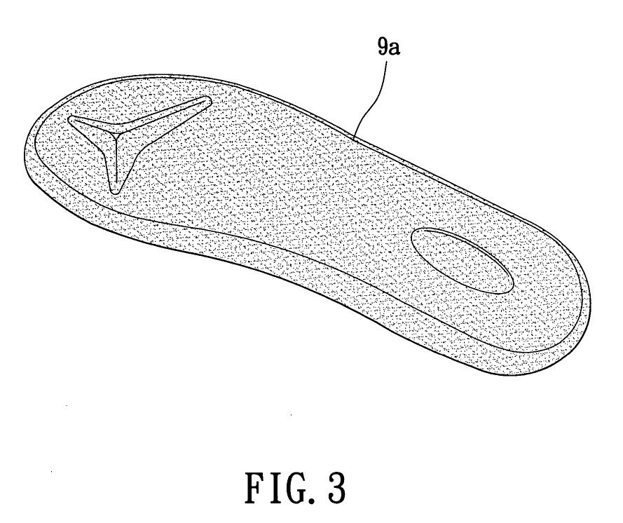

(i) a ninth step of trimming: using a trimming device 90 to trim the foam cushion 9 to become a finished foam cushion 9a, such as an insole or a sports cushion, as shown in FIG. 3.

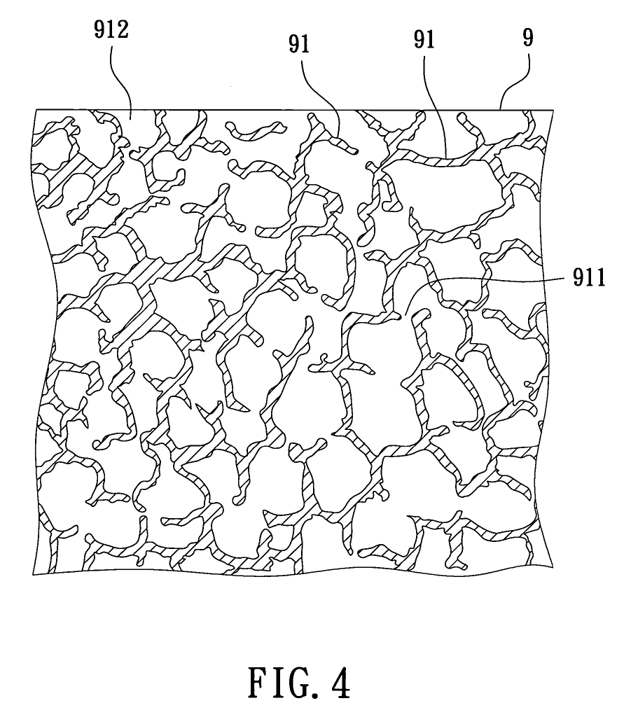

The paste layer 8 is able to break cells before it is gelled completely, forming cells 91 with various sizes and opened to one another, due to a complete mixing and reaction, a pre-blowing procedure as long as 8 hours for controlling effectively the viscosity of the paste, an open laying under a stationary heating for growing freely cells. And, the foam cushion 9 or the finished foam cushion 9a, such as an insole or a sports cushion, as shown in FIG. 3 and 4, can form open cells 91, which may reach an approximate 94%. The walls isolating the abutting cells 91 inside the foam cushion 9 are properly broken to form inner air ways 911. The walls of the cells 91 at the outermost surface of the foam cushion 9 are properly broken to form breathing holes 912. Therefore, when the finished foam cushion 9a, such as an insole, is treaded on by a user, the air in the cells 91 will spread through the cells 91 and out of the finished foam cushion 9a, so as to buffer the rebounding of the finished foam cushion 9a, making the feet feel tender and comfortable and reducing fatigue. In addition, when feet or another part of a human body, in contact with the foam product 91 sweat, the sweat can penetrate through the breathing holes 912 and then, be absorbed quickly by the air ways 911 between the cells 91, keeping the feet or the other part of a human body dry, preventing it from growing fungi and providing a comfortable wearing. Of course, when the finished foam cushion 9a is not used, the sweat or moisture absorbed inside it can be evaporated off easily through the breathing holes 912 and air ways 911, keeping the finished foam cushion 9a dry.

While the preferred embodiment of the invention has been described above, it will be recognized and understood that various modifications may be made therein and the appended claims are intended to cover all such modifications that may fall within the spirit and scope of the invention.

What is claimed is:

1. A foam cushion with a high water-absorption ability principally using PVC powder as its material and having numerous air cells, said air cells in said foam cushion having air ways broken properly among abutting air cells, said air cells on the outermost surface of said foam cushion having breathing holes open properly to outer air.

2. A foam cushion with a high water-absorption ability as claimed in claim 1, wherein said foam cushion can be formed to have a preset figure and texture, by means of a thermal mold and a trimming device.

3. A foam cushion with a high water-absorption ability as claimed in claim 1, wherein said foam cushion has an open-cell area of approximate 94%.
